(19) United States
(12) Patent Application Publication
(10) Pub. No.: US 2022/0398572 A1
(43) Pub. Date: Dec. 15, 2022

(54) SYSTEMS AND METHODS FOR CONTROLLING TRANSFERS OF DIGITAL ASSETS

(71) Applicant: Shopify Inc., Ottawa (CA)

(72) Inventor: John Jong-Suk LEE, Waterloo (CA)

(73) Assignee: Shopify Inc., Ottawa (CA)

(21) Appl. No.: 17/344,251

(22) Filed: Jun. 10, 2021

(51) Int. Cl. G06Q 20/38; G06Q 20/40; G06Q 20/36

(52) U.S. Cl. CPC G06Q 20/389; G06Q 20/407; G06Q 20/367; G06Q 10/087

(57) ABSTRACT

A computer-implemented method is disclosed. The method includes: receiving a request to transfer a digital asset; appending, to a blockchain of a blockchain network, a transaction for deploying a smart contract for executing a transfer of the digital asset; receiving a first notification of an off-chain transaction in connection with transfer of the digital asset; sending a first transaction to the blockchain for invoking a first function of the smart contract to allow transfer of the digital asset to a destination address; and responsive to detecting a first condition associated with the off-chain transaction, sending a second transaction to the blockchain for invoking a second function of the smart contract for transferring the digital asset to the destination address. Related methods, apparatus, and computer-readable media are also disclosed.

### TECHNICAL FIELD

The present disclosure relates to digital assets and, in particular, to systems and methods for decentralized control of transfers of digital assets.

### BACKGROUND

A distributed computing network may facilitate exchange of digital assets. In particular, a blockchain-run platform may handle transfers of digital assets. Off-chain transactions may pose various technical challenges for blockchain implementations of digital asset transfer systems. It is desirable to ensure the high level of security that a blockchain-based solution offers while maintaining flexibility to handle off-chain transactions in connection with transfers of digital assets.

### BRIEF DESCRIPTION OF THE DRAWINGS

Embodiments will be described, by way of example only, with reference to the accompanying figures wherein:

FIG. 1 illustrates an example network associated with a blockchain;

FIG. 2 illustrates an example system for processing transfers of digital assets, including a digital asset transfer management engine;

FIG. 3 shows, in flowchart form, an example method for processing transfers of digital assets between parties;

FIG. 4 shows, in flowchart form, an example method for tracking inventory of digital assets on a blockchain;

FIG. 5 shows, in flowchart form, another example method for processing transfers of digital assets between parties;

FIG. 6 is a block diagram of an e-commerce platform, in accordance with an example embodiment; and

FIG. 7 is an example of a home page of an administrator, in accordance with an example embodiment.

### DETAILED DESCRIPTION OF EMBODIMENTS

In an aspect, the present application discloses a computer-implemented method. The method includes: receiving a request to transfer a digital asset; appending, to a blockchain of a blockchain network, a transaction for deploying a smart contract for executing a transfer of the digital asset; receiving a first notification of an off-chain transaction in connection with transfer of the digital asset; sending a first transaction to the blockchain for invoking a first function of the smart contract to allow transfer of the digital asset to a destination address; and responsive to detecting a first condition associated with the off-chain transaction, sending a second transaction to the blockchain for invoking a second function of the smart contract for transferring the digital asset to the destination address.

In some implementations, detecting the first condition may include detecting expiry of a defined period associated with the off-chain transaction.

In some implementations, the method may further include: receiving a second notification of a request to process a chargeback prior to expiry of the defined period; and responsive to the second notification, sending a third transaction to the blockchain for invoking a third function of the smart contract to change the destination address.

In some implementations, the first and second transactions may be sent using a digital wallet associated with an e-commerce platform that facilitates transfer of the digital asset from a merchant offering the digital asset for sale on the e-commerce platform.

In some implementations, the method may further include: verifying inventory information for the digital asset, and the first transaction may be sent in response to verifying the inventory information.

In some implementations, verifying inventory information may include: determining a first quantity of the digital asset that is available for sale; and comparing the first quantity to a second number of transactions sent by a digital wallet associated with an e-commerce platform for invoking a function of the smart contract to effect transfer of the digital asset.

In some implementations, determining the first quantity of the digital asset may include: identifying one or more digital wallets controlled by a seller of the digital asset; and determining a total quantity of the digital asset associated with the identified digital wallets.

In some implementations, the off-chain transaction may include a payment transaction in connection with the transfer of the digital asset, the payment transaction processed via a third-party payment gateway.

In some implementations, the smart contract may include an indication of at least: a seller wallet address for a digital wallet associated with a seller of the digital asset; a buyer wallet address for a digital wallet associated with a buyer of the digital wallet; and a platform wallet address for a digital wallet associated with an e-commerce platform.

In some implementations, the digital asset may be a non-fungible cryptographic token.

In another aspect, the present application discloses a computing system. The computing system includes a processor and a memory storing computer-executable instructions that, when executed, are to cause the processor to: receive a request to transfer a digital asset; append, to a blockchain of a blockchain network, a transaction for deploying a smart contract for executing a transfer of the digital asset; receive a first notification of an off-chain transaction in connection with transfer of the digital asset; send a first transaction to the blockchain for invoking a first function of the smart contract to allow transfer of the digital asset to a destination address; and responsive to detecting a first condition associated with the off-chain transaction, send a second transaction to the blockchain for invoking a second function of the smart contract for transferring the digital asset to the destination address.

In yet another aspect, a non-transitory, computer readable storage medium is disclosed. The computer readable storage medium contains instructions thereon which, when executed by a processor, are to cause the processor to: receive a request to transfer a digital asset; append, to a blockchain of a blockchain network, a transaction for deploying a smart contract for executing a transfer of the digital asset; receive a first notification of an off-chain transaction in connection with transfer of the digital asset; send a first transaction to the blockchain for invoking a first function of the smart contract to allow transfer of the digital asset to a destination address; and responsive to detecting a first condition associated with the off-chain transaction, send a second transaction to the blockchain for invoking a second function of the smart contract for transferring the digital asset to the destination address.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . and . . . ” is intended to cover any one or more of the listed elements, including any one of the listed elements alone, any sub-combination, or all of the elements, without necessarily excluding any additional elements, and without necessarily requiring all of the elements.

In the present application, the term “product data” refers generally to data associated with products that are offered for sale on an e-commerce platform. The product data for a product may include, without limitation, product specification, product category, manufacturer information, pricing details, stock availability, inventory location(s), expected delivery time, shipping rates, and tax and tariff information. While some product data may include static information (e.g., manufacturer name, product dimensions, etc.), other product data may be modified by a merchant on the e-commerce platform. For example, the offer price of a product may be varied by the merchant at any time. In particular, the merchant may set the product's offer price to a specific value and update said offer price as desired. Once an order is placed for the product at a certain price by a customer, the merchant commits to pricing; that is, the product price may not be changed for the placed order. Product data that a merchant may control (e.g., change, update, etc.) will be referred to as variable product data. More specifically, variable product data refers to product data that may be changed automatically or at the discretion of the merchant offering the product.

In the present application, the term “e-commerce platform” refers broadly to a computerized system (or service, platform, etc.) that facilitates commercial transactions, namely buying and selling activities over a computer network (e.g., Internet). An e-commerce platform may, for example, be a free-standing online store, a social network, a social media platform, and the like. Customers can initiate transactions, and associated payment requests, via an e-commerce platform, and the e-commerce platform may be equipped with transaction/payment processing components or delegate such processing activities to one or more third-party services. An e-commerce platform may be extendible/extensible by connecting one or more additional sales channels representing platforms where products can be sold. In particular, the sales channels may themselves be e-commerce platforms, such as Facebook Shops™, Amazon™, etc.

In the present application, the term “blockchain” is used to include all forms of electronic, computer-based, distributed ledgers. These include, but are not limited to, blockchain and transaction-chain technologies, permissioned and un-permissioned ledgers, shared ledgers, and variations thereof.

A blockchain is a consensus-based, electronic ledger which is implemented as a computer-based, decentralised distributed system made up of blocks which in turn are made up of transactions. Each transaction is a data structure that encodes the transfer of control of a digital asset between participants in the blockchain system, and includes at least one input and at least one output. Each block contains a hash of the previous block so that blocks become chained together to create a permanent, unalterable record of all transactions which have been written to the blockchain since its inception. Transactions contain small programs known as scripts embedded into their inputs and outputs, which specify how and by whom the outputs of the transactions can be accessed.

Network nodes that receive a new transaction will try to push that transaction out to other nodes in the network. Before transmitting a new transaction to other nodes, it is “validated”; that is, the transaction is checked against a set of criteria to ensure that it meets the basic requirements for a proper transaction according to the applicable blockchain protocol.

In order for a transaction to be written to the blockchain, it is incorporated into a block by a node (a “miner” or “mining node”) that is designed to collect transactions and form them into blocks. The miner then attempts to complete a “proof of work” with respect to the node. Miners throughout the blockchain network compete to be the first to assemble a block of transactions and complete the associated proof of work for that block. The successful miner adds its confirmed block to the blockchain and the block is propagated through the network so that other nodes that maintain a copy of the blockchain can update their records. Those nodes receiving a block also “validate” that block and all the transactions in it to ensure it complies with the formal requirements of the protocol.

### Decentralized Control of Transfers of Digital Assets

“Digital assets” refer to assets that are in digital format and that come with the right to use. In particular, a digital asset is self-contained, uniquely identifiable, and is associated with a defined value or ability to use. Examples of digital assets include, among others, digital documents, multimedia files (e.g., photos, audiovisual media, animations, etc.), electronic mails, websites, cryptocurrencies, digital wallets, and asset-backed tokens.

Blockchain technology has created new efficiencies in the markets and is often a favored medium in which to exchange digital assets. Blockchains allow parties to unequivocally prove certain aspects of a digital asset, such as ownership, authenticity, and transactions history, without the need to involve a centralized or intermediary entity. Blockchains produce a structure of data with inherent security qualities—combining cryptography, decentralization and consensus, blockchain technology can ensure trust in the transactions that are conducted on blockchain-run platforms.

The rapid growth of software applications and the blockchain-based asset space has given rise to various different types of digital assets. An example of a digital asset class that has been garnering a great deal of interest is non-fungible tokens, or NFTs. NFTs are unique digital assets having blockchain-based authenticity, ownership, and transferability features. More specifically, an NFT is a unit of data stored on a blockchain that certifies a digital asset to be unique. NFTs can represent a wide range of assets, physical or digital, including but not limited to: digital art, collectible items, music, digital movies, games, and the like. An NFT functions as a digital certificate of ownership for any assigned digital asset. A key feature of NFTs is that they are not mutually interchangeable—each NFT has a unique identification code and metadata such that it is distinguishable from any other NFT. The unique identity and ownership of an NFT is verifiable using the blockchain ledger.

Blockchain networks, like Ethereum, have token standards that enable developers to deploy NFTs and ensure that they are compatible with the broader ecosystem, including exchanges and wallet services. NFTs can be sold and bought by means of off-chain transactions. In particular, a buyer may conduct an off-chain payment to acquire an NFT and upon successful completion of the payment transaction, the NFT can be transferred from the owner/seller to the buyer. For example, the NFT may be transferred from a seller's digital wallet to the buyer's digital wallet on completion of an off-chain payment. It is desired to maintain the high level of security of a blockchain-based solution for transferring digital assets while maintaining the flexibility to handle off-chain transactions in connection with the transfers.

Scarcity of an NFT of a digital asset is what drives its value. When transacting in NFTs, it is often challenging to track inventory levels of the NFT. In an NFT transaction written on a blockchain, there is a delay between the sending of a transaction and a ledger update based on the transaction. Such delay may result in a temporary mismatch between the inventory of the NFT and quantity of the NFT that is programmatically available. It is desired to ensure that transactions in NFTs maintain the scarcity of the NFT. In particular, a mechanism for ensuring proper tracking of the inventory of an NFT is desired.

Various technical solutions for controlling the transfer of digital assets, such as NFTs, are described herein. More specifically, a blockchain-based solution for managing transfer of digital assets conducted on an e-commerce platform is disclosed.

A smart contract for transferring digital assets is deployed on a blockchain (e.g., Ethereum blockchain). The smart contract indicates at least a merchant wallet address, a destination (i.e., buyer) wallet address, and an e-commerce platform wallet address. The e-commerce platform waits to confirm an off-chain transaction, e.g., a financial payment transaction, in connection with the sale/transfer of the digital asset. Upon confirming the off-chain transaction, the e-commerce platform wallet sends a first transaction to the blockchain for invoking a first function of the smart contract to allow for movement of the digital asset. A transfer of the underlying digital asset does not occur until a chargeback/refund period for the off-chain transaction has expired.

Upon expiry of the chargeback/refund period, the e-commerce platform wallet sends a second transaction for invoking a second function of the smart contract to move the digital asset to the receiver's wallet. If the sale/transfer is revoked during the chargeback/refund period, the e-commerce platform wallet may overwrite the destination address of the smart contract to roll back movement of the digital asset through the chain of ownership (i.e., back to the merchant wallet).

Additionally, a solution for managing blockchain inventory of a digital asset is proposed. The solution may be implemented by, for example, an e-commerce system. More specifically, an e-commerce platform that facilitates secondary trading of a digital asset may implement the proposed solution of the present application in managing inventory of the digital assets that are transferred via the e-commerce platform.

The blockchain wallets (e.g., Ethereum wallets) that are controlled by the seller of a digital asset are onboarded to a blockchain ledger. The initial inventory of the digital asset is scanned on the ledger. Upon successful verification of a payment in connection with a sale of the digital asset in an off-chain payment gateway, a blockchain wallet (i.e., software application) belonging to the e-commerce platform sends a transaction to the blockchain for invoking a function of a smart contract that is in control of the digital asset. The wallet of the e-commerce platform can be used as a proxy for inventory control of a digital asset that is offered for sale. In particular, the e-commerce platform may track inventory information of NFTs on the blockchain and confirmatory transactions sent by the wallet of the e-commerce platform.

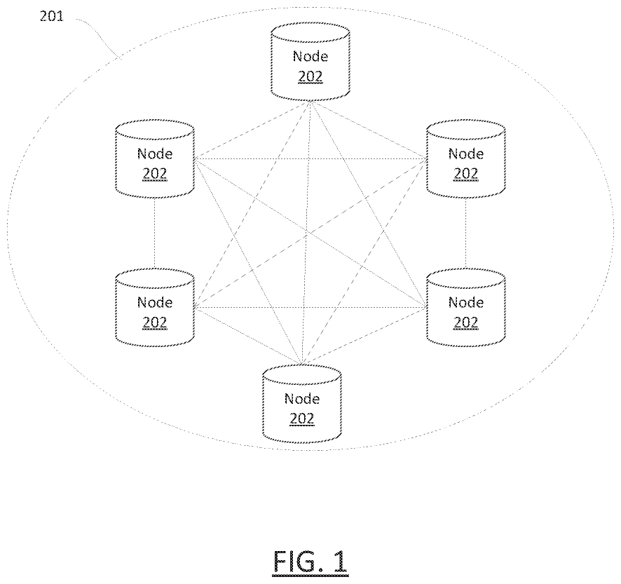

Reference is first made to FIG. 1, which illustrates, in block diagram form, an example network associated with a blockchain, which may be referred to herein as a blockchain network 201. The blockchain network 201 is a peer-to-peer open membership network which may be joined by anyone, without invitation or without consent from other members. Distributed electronic devices running an instance of the blockchain protocol under which the blockchain network 201 operates may participate in the blockchain network 201. Such distributed electronic devices may be referred to as nodes 202. The blockchain protocol may be an Ethereum protocol, or another cryptocurrency, for example.

The electronic devices that run the blockchain protocol and that form the nodes 202 of the blockchain network 201 may be of various types including, for example, computers such as desktop computers, laptop computers, tablet computers, servers, mobile devices such as smartphones, wearable computers such as smart watches or other electronic devices.

Nodes 202 of the blockchain network 201 are coupled to one another using suitable communication technologies which may include wired and wireless communication technologies. In many cases, the blockchain network 201 is implemented at least partly over the Internet, and some of the nodes 202 may be located in geographically dispersed locations.

Nodes 202 maintain a global ledger of all transactions on the blockchain, grouped into blocks, each of which contains a hash of the previous block in the chain. The global ledger is a distributed ledger and each node 202 may store a complete copy or a partial copy of the global ledger. Transactions by a node 202 affecting the global ledger are verified by other nodes 202 so that the validity of the global ledger is maintained. The details of implementing and operating a blockchain network, such as one using the Ethereum protocol, will be appreciated by those ordinarily skilled in the art.

Each transaction typically has one or more inputs and one or more outputs. Scripts embedded into the inputs and outputs specify how and by whom the outputs of the transactions can be accessed. The output of a transaction may be an address to which value (or a digital asset) is transferred as a result of the transaction. That value is then associated with that output address as an unspent transaction output (UTXO). A subsequent transaction may then reference that address as an input in order to spend or disperse that value.

Nodes 202 can fulfil numerous different functions, from network routing to wallet services, to maintain a robust and secure decentralized public ledger. “Full nodes” contain a complete and up-to-date copy of the blockchain, and can therefore verify any transactions (spent or unspent) on the public ledger. “Lightweight nodes” (or SPV) maintain a subset of the blockchain and can verify transactions using a “simplified payment verification” technique. Lightweight nodes only download the headers of blocks, and not the transactions within each block. These nodes therefore rely on peers to verify their transactions. “Mining nodes”, which can be full or lightweight nodes, are responsible for validating transactions and creating new blocks on the blockchain. “Wallet nodes”, which are typically lightweight nodes, handle wallet services of users. Nodes 202 communicate with each other using a connection-oriented protocol, such as TCP/IP (Transmission Control Protocol).

When a node wishes to send a transaction to a peer, an “INVENTORY” message is sent to the peer, transmitting one or more inventory objects that is known to the transmitting node. If the peer replies with a “GETDATA” message, i.e., a full transaction request, the transaction is sent using a “TRANSACTION” message. The node receiving the transaction may forward it in the same manner—given that it is a valid transaction—to its peers.

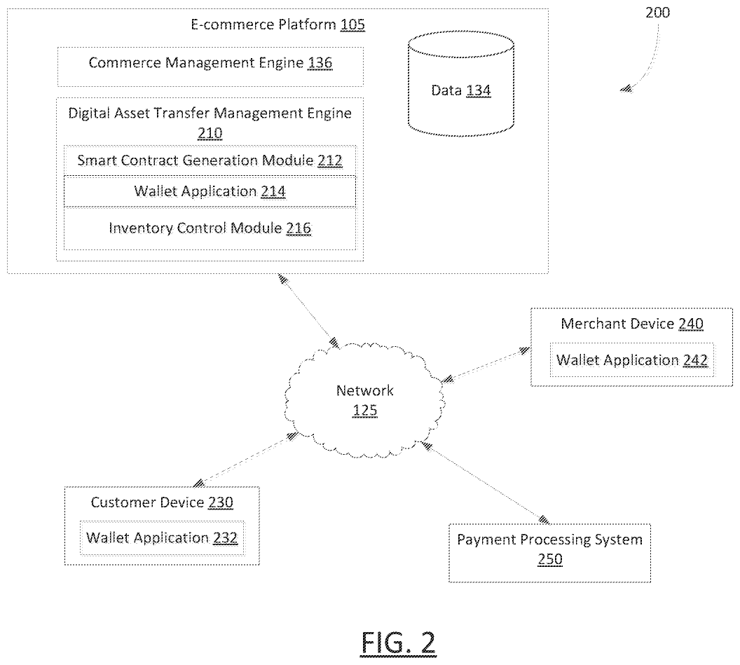

FIG. 2 illustrates an exemplary computing environment 200 consistent with certain disclosed embodiments. As shown in FIG. 2, the computing environment 200 may include the e-commerce platform 105, customer device 230, merchant device 240, a payment processing system 250, and a communications network 125 connecting one or more of the components of computing environment 200.

As illustrated, the customer device 230 and the merchant device 240 communicate via the network 125. In at least some embodiments, each of the customer device 230 and the merchant device 240 may be a computing device. The customer device 230 and the merchant device 240 may take a variety of forms including, for example, a mobile communication device such as a smartphone, a tablet computer, a wearable computer (such as a head-mounted display or smartwatch), a laptop or desktop computer, or a computing device of another type.

The merchant device 240 is associated with a merchant, or seller, of digital assets. In particular, the merchant device 240 enables a merchant to initiate transfer of a digital asset that is associated with the merchant. The merchant may, for example, be a merchant that sells products, such as digital assets, on the e-commerce platform 105. For example, the merchant may be associated with one or more online storefronts provided via the e-commerce platform 105. In at least some embodiments, the merchant device 240 may have resident thereon a merchant wallet application 242. The merchant wallet application 242 may be a standalone mobile application, a web application accessible via a web browser, or a desktop application. The merchant wallet application 242 is an application that lets the merchant interact with their blockchain account. For example, the merchant wallet application 242 may allow the merchant to view their balances and transactions history, send transactions, encrypt and/or sign information, and connect to other applications. The merchant wallet application 242 may store various types of data, such as keys (e.g., public and/or private keys) for cryptocurrency transactions and digital assets (e.g., tokens such as NFTs) associated with the merchant.

The customer device 230 is associated with a buyer of digital assets. In particular, the customer device 230 may be associated with a customer of a merchant offering digital assets via the e-commerce platform 105. In at least some embodiments, the customer device 230 may have resident thereon a buyer wallet application 232. The buyer wallet application 232 may be a standalone mobile application, a web application accessible via a web browser, or a desktop application. The buyer wallet application 232 is an application that lets the buyer interact with their blockchain account. For example, the buyer wallet application 232 may allow the buyer to view their balances and transactions history, send transactions, encrypt and/or sign information, and connect to other applications. The buyer wallet application 232 may store various types of data, such as keys (e.g., public and/or private keys) for cryptocurrency transactions and digital assets (e.g., tokens such as NFTs) associated with the buyer.

The customer device 230 and/or the merchant device 240 may be communicably connected to the e-commerce platform 105. In at least some embodiments, the customer device 230 and the merchant device 240 may be associated with accounts of the e-commerce platform 105. More specifically, the customer device 230 and the merchant device 240 may be associated with entities (e.g., individuals) that have accounts in connection with the e-commerce platform 105. For example, one or more customer devices 230 and merchant device 230 may be associated with customers (e.g., customers having e-commerce accounts) or merchants having one or more online stores in the e-commerce platform 105. The e-commerce platform 105 may store indications of associations between buyer/merchant device and merchants or customers of the e-commerce platform, for example, in the data facility 134.

The payment processing system 250 processes payment requests. The payment processing system 250 includes various payment processing components, including payment servers and payment gateways (not shown). A payment gateway is a third-party operated gateway that receives payment requests from various sources and locations, extracts necessary data from each payment request, and formats it into a prescribed format for transmission to a payment server operated by a payment processor, such as a credit card company, bank, or the like. A payment gateway is typically a first step in payment processing; it may pass along payment information to a specific payment processor to complete the payment processing. The payment gateway receives a success or failure message from the payment processor and prepares and sends a response message to a sender of the payment request.

FIG. 2 also illustrates the e-commerce platform 105. In at least some embodiments, the e-commerce platform 105 may provide a processing facility for transferring digital assets that are sold and purchased on the e-commerce platform. More particularly, components of the e-commerce platform 105 may be configured to control transfers of digital assets that are conducted using a blockchain network.

The e-commerce platform 105 includes a commerce management engine 136, a digital asset transfer management engine 210, and a data facility 134. The commerce management engine 136 may be configured to handle various operations in connection with e-commerce accounts that are associated with the e-commerce platform 105. For example, the commerce management engine 136 may be configured to retrieve e-commerce account information for various entities (e.g., merchants, customers, etc.) and historical account data, such as transaction events data, browsing history data, and the like, for selected e-commerce accounts. In particular, the commerce management engine 136 may obtain account information for e-commerce accounts of buyers and/or merchants that are associated with the e-commerce platform 105.

A digital asset transfer management engine 210 is provided in the e-commerce platform 105 of FIG. 2. The digital asset transfer management engine 210 may be a software-implemented module containing processor-executable instructions that, when executed by one or more processors in the e-commerce platform 105, cause the e-commerce platform 105 to carry out some of the processes and functions described herein. In some embodiments, the digital asset transfer management engine 210 may be provided as a service that is external to the e-commerce platform 105. In particular, the e-commerce platform 105 may engage the digital asset transfer management engine 210 as a service that is independent of the e-commerce platform 105 and which facilitates processing of digital asset transfers between entities that are associated with the e-commerce platform 105. More broadly, in some implementations, the subject matter of the present application may be employed in manners independent of a particular e-commerce platform. For example, it may be that the digital asset transfer management engine 210 is implemented and deployed so as to be independent of any e-commerce platform.

The digital asset transfer management engine 210 is configured to receive requests to transfer digital assets from merchants associated with the e-commerce platform 105. As will be described in greater detail below, the e-commerce platform 105 may be configured to control blockchain-based transfers of digital assets between merchants and customers. In particular, the digital asset transfer management engine 210 may enable the e-commerce platform 105 to perform various functions to enable transfers of digital assets using a blockchain network.

The digital asset transfer management engine 210 includes a smart contract generation module 212. A smart contract is a computer program that runs on a blockchain (e.g., the Ethereum blockchain or another distributed ledger) which is intended to automatically execute, control or otherwise implement transactions according to the terms of a contract. More specifically, a smart contract refers to a collection of code and data that is deployed using cryptographically signed transactions on a blockchain network and that resides at a specific address on the blockchain. A smart contract is deployed on a blockchain by sending a transaction, for example, from a wallet for the blockchain. Once that transaction is included in a block that is added to the blockchain, the code of the smart contract will automatically execute.

The smart contract generation module 212 is configured to generate the computer code for smart contracts that are deployed on a blockchain network. In particular, the smart contract generation module 212 creates smart contracts that are designed to control transfer of digital assets of merchants associated with the e-commerce platform 105. That is, the transfer of digital assets using a blockchain may be controlled by means of smart contracts that are defined by the e-commerce platform 105.

The digital asset transfer management engine 210 also includes an e-commerce platform wallet application 214. The e-commerce platform wallet application 214 is a wallet application that allows for interacting with an account associated with a blockchain (e.g., an Ethereum account). The account may, for example, be an account of the e-commerce platform 105. That is, the e-commerce platform wallet application 214 allows the e-commerce platform 105 to send transactions, encrypt and/or sign information, or otherwise interact with a blockchain. In particular, the e-commerce platform 105 may interact with smart contracts that are deployed on the blockchain by sending transactions using the e-commerce platform wallet application 214. The balances, transactions history, and the like may be stored and/or accessed on the e-commerce platform wallet application 214.

The digital asset transfer management engine 210 also includes an inventory control module 216. The inventory control module 216 allows the e-commerce platform 105 to track inventory of digital assets that are offered for sale by merchants associated with the e-commerce platform 105. In particular, the inventory control module 216 is configured to determine the inventory of digital assets that are available for transferring on a blockchain network. In at least some embodiments, the inventory control module 216 may interface with a blockchain network to access a distributed ledger associated with the blockchain in order to track digital assets and their movements via transactions of the blockchain.

The functionality described herein may be used in commerce to provide improved customer or buyer experiences. The e-commerce platform 105 could implement the functionality for any of a variety of different applications, examples of which are described herein. Although the digital asset transfer management engine 210 of FIG. 2 is illustrated as a distinct component of the e-commerce platform 105, this is only an example. An engine could also or instead be provided by another component residing within or external to the e-commerce platform 105. In some embodiments, either or both of the applications 142A-B may provide an engine that implements the functionality described herein to make it available to customers and/or to merchants. Furthermore, in some embodiments, the commerce management engine 136 may provide that engine. However, the location of the digital asset transfer management engine 210 may be implementation specific. In some implementations, the digital asset transfer management engine 210 may be provided at least in part by an e-commerce platform, either as a core function of the e-commerce platform or as an application or service supported by or communicating with the e-commerce platform. Alternatively, the digital asset transfer management engine 210 may be implemented as a stand-alone service to clients such as a customer device or a merchant device. In addition, at least a portion of such an engine could be implemented in the merchant device and/or in the customer device. For example, a customer device could store and run an engine locally as a software application.

The digital asset transfer management engine 210 is configured to implement at least some of the functionality described herein. Although the embodiments described below may be implemented in association with an e-commerce platform, such as (but not limited to) the e-commerce platform 105, the embodiments described below are not limited to e-commerce platforms.

The data facility 134 may store data collected by the e-commerce platform 105 based on the interaction of merchants and customers with the e-commerce platform 105. For example, merchants provide data through their online sales activity. Examples of merchant data for a merchant include, without limitation, merchant identifying information, product data for products (e.g., digital assets) offered for sale, online store settings, geographical regions of sales activity, historical sales data, and inventory locations. Customer data, or data which is based on the interaction of customers and prospective purchasers with the e-commerce platform 105, may also be collected and stored in the data facility 134. Such customer data may be obtained on the basis of inputs received via customer devices associated with the customers and/or prospective purchasers. By way of example, historical transaction events data including details of purchase transaction events by customers on the e-commerce platform 105 may be recorded and such transaction events data may be considered customer data. Such transaction events data may indicate product identifiers, date/time of purchase, final sale price, purchaser information (including geographical region of customer), and payment method details, among others. Other data vis-à-vis the use of e-commerce platform 105 by merchants and customers (or prospective purchasers) may be collected and stored in the data facility 134.

The data facility 134 may include customer preference data for customers of the e-commerce platform 105. For example, the data facility 134 may store account information, order history, browsing history, and the like, for each customer having an account associated with the e-commerce platform 105. The data facility 134 may additionally store, for a plurality of e-commerce accounts, wish list data and cart content data for one or more virtual shopping carts.

As described above, the e-commerce platform 105, the customer device 230, the merchant device 240, and the payment processing system 250 are computing systems. In particular, each of the e-commerce platform 105, the customer device 230, the merchant device 240, and the payment processing system 250 (or components thereof, such as wallet applications, and the like) may be a node, such as node 202, of a blockchain network.

The network 125 is a computer network. In some embodiments, the network 125 may be an internetwork such as may be formed of one or more interconnected computer networks. For example, the network 125 may be or may include an Ethernet network, an asynchronous transfer mode (ATM) network, a wireless network, or the like.

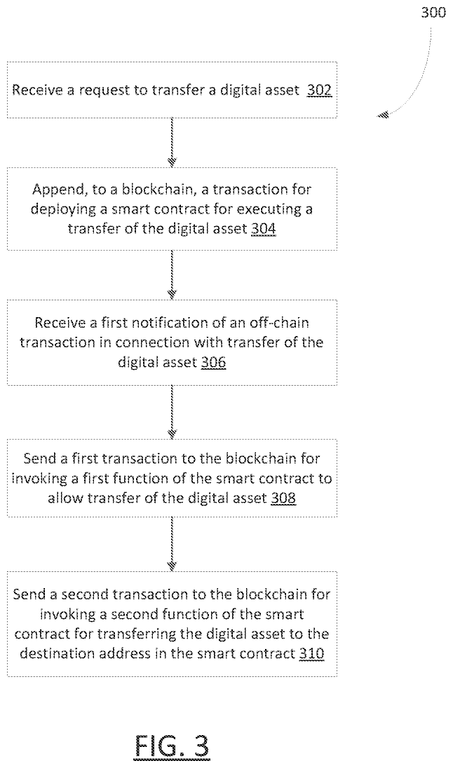

Reference is now made to FIG. 3, which shows, in flowchart form, an example method 300 for processing transfers of digital assets between parties. The method 300 may be performed by a computing system that implements asset transfer control, such as the digital asset transfer management engine 210 of FIG. 2. As detailed above, the digital asset transfer management engine may be a service that is provided within or external to an e-commerce platform to facilitate, among others, transfer of digital assets between merchants and customers associated with the e-commerce platform. In particular, the method 300 may be included as part of a process for transferring, in real-time, digital assets via a blockchain network.

In operation 302, the digital asset transfer management engine receives a request to transfer a digital asset. The digital asset may, for example, be a cryptographic token, such as a non-fungible token (NFT). In some embodiments, the request for transfer of a digital asset may be received from a merchant. For example, a merchant that owns a digital asset may generate a request, directed to the e-commerce platform, for transferring the digital asset to a customer (i.e., buyer of the digital asset) of the merchant. The request data for the transfer request may include, at least, an identifier of the merchant, an identifier of the buyer, and asset data of the digital asset. Additionally, the request data may indicate blockchain addresses associated with the merchant and the buyer for a particular blockchain network. In particular, the request data may specify wallet addresses associated with digital wallets for the blockchain that belong to the merchant and the buyer.

Additionally, or alternatively, the request to transfer the digital asset may be received from a customer of a merchant that is associated with the e-commerce platform. For example, upon purchasing a digital asset from a merchant, a customer may request verification of ownership of the digital asset by the merchant and/or delivery of the digital asset to a digital wallet for a blockchain that belongs to the customer. In such cases, the digital asset transfer management engine may first confirm that the requesting customer is entitled to acquire the digital asset from the merchant. For example, the digital asset transfer management engine may query the merchant in order to determine whether a purchase of the digital asset was made and whether the requesting customer was the purchaser of the digital asset.

Upon receiving the request for transfer of the digital asset, a smart contract that controls the digital asset is created by the digital asset transfer management engine. In at least some embodiments, the smart contract is a computer program that defines, at least, the digital asset that is to be transferred (including asset data for the digital asset), a merchant wallet address, a buyer wallet address, and an e-commerce platform wallet address. The smart contract includes code defining functions (or actions) that can be performed by the smart contract and data indicating values and/or states associated with the smart contract.

Various functions may be defined in the smart contract. In at least some embodiments, the following functions may be defined: a “TRANSFER” function for transferring a digital asset to a destination address (e.g., the address of a buyer wallet); a “REVOKE” function for changing a destination address for a transfer of the digital asset; and a “VALIDATE” function that serves as a precondition for a transfer of the digital asset. Accounts of the blockchain (e.g., merchant account, buyer account, e-commerce platform account) can submit transactions for executing one or more of the functions defined in the smart contracts.

In operation 304, the digital asset transfer management engine appends, to a blockchain of a blockchain network, a transaction for deploying a smart contract for executing a transfer of the digital asset. More specifically, the smart contract that controls the digital asset is deployed on the blockchain. For example, a transaction may be sent from the e-commerce platform wallet application for the blockchain, and the transaction may be included in a block that is added to the blockchain. The transaction includes, at least, the compiled code (e.g., functions, states, etc.) for the smart contract.

In operation 306, the digital asset transfer management engine receives a first notification of an off-chain transaction in connection with transfer of the digital asset. The off-chain transaction refers to a transaction between the merchant (i.e., seller of the digital asset) and customer (i.e., buyer) that occurs outside of the blockchain. In at least some embodiments, the off-chain transaction may be a payment transaction that is processed independently of the blockchain. For example, the payment transaction may be processed by a payment processor, such as the payment processing system 250 of FIG. 2. The payment transaction may be a payment (e.g., credit or debit payment, cryptocurrency transaction, etc.) from the customer to the merchant for acquiring the digital asset from the merchant. Upon completion of the off-chain transaction, the digital asset transfer management engine receives the first notification indicating that the transaction has been processed. For example, a payment processing system may transmit, to the digital asset transfer management engine, a message indicating that a payment from the customer to the merchant in connection with the acquisition of the digital asset has been completed.

In operation 308, the digital asset transfer management engine sends a first transaction to the blockchain for invoking a first function of the smart contract to allow transfer of the digital asset to a destination address. The first transaction is a dedicated transaction for interacting with the smart contract that serves as a validation step for a transfer of the digital asset. In particular, the first transaction represents an acknowledgement of completion of an off-chain transaction in connection with the transfer of the digital asset that is controlled by the smart contract.

In operation 310, responsive to detecting a first condition associated with the off-chain transaction, the digital asset transfer management engine sends a second transaction to the blockchain for invoking a second function of the smart contract for transferring the digital asset to the destination address. In some embodiments, the first condition may relate to a length of time associated with the off-chain transaction. More particularly, the first condition may define an expiry period (or an expiry length of time) associated with the off-chain transaction after which the digital asset may be transferred to the current destination address for the transfer. That is, upon the expiry of a predefined period of time, the digital asset transfer management engine is configured to send a transaction, to the blockchain, that calls a function for initiating the transfer of the digital asset. In particular, the digital asset is transferred to a buyer (e.g., a buyer wallet) of the digital asset.

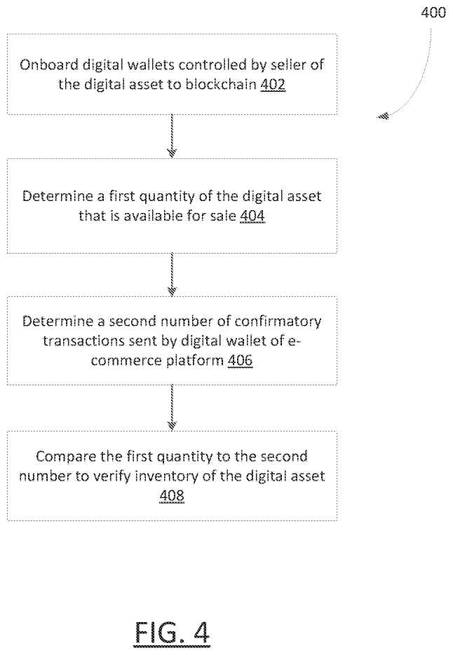

Reference is made to FIG. 4, which shows, in flowchart form, an example method 400 for tracking inventory of digital assets on a blockchain. The method 400 may be performed by a computing system that implements asset transfer control, such as the digital asset transfer management engine 210 of FIG. 2. The digital asset transfer management engine may be a service that is provided within or external to an e-commerce platform to facilitate, among others, transfer of digital assets between merchants and customers associated with the e-commerce platform. In particular, the method 400 may be included as part of a process for transferring, in real-time, digital assets via a blockchain network. The operations of method 400 may be performed in addition to, or as alternatives of, one or more of the operations of method 300 of FIG. 3.

In operation 402, the digital asset transfer management engine onboards one or more digital wallets that are controlled by a seller of a digital asset to a blockchain. In particular, the digital asset transfer management engine may append wallet data associated with the digital wallets of a seller (e.g., a merchant) to a ledger associated with the blockchain. The wallet data that is added to the ledger may be selected by the seller. That is, the wallet data of digital wallets of the seller is selectively added to the blockchain.

In operation 404, the digital asset transfer management engine determines a first quantity of the digital asset that is available for sale. The first quantity may, for example, be the total number of the digital asset that is included in the digital wallets of the seller and which have been added to the blockchain ledger.

In operation 406, the digital asset transfer management engine determines a second number of confirmatory transactions sent by a digital wallet associated with the e-commerce platform. As described with reference to method 300, an e-commerce platform may interact with a smart contract controlling a digital asset by means of transactions that confirm, among others, completion of an off-chain transaction in connection with the digital asset. In other words, the number of confirmatory transactions may serve as a proxy for the inventory control. In particular, the inventory of the digital asset for sale by the seller may be reduced by the number of the confirmatory transactions, which can be determined by checking the transactions history of the e-commerce platform wallet.

In operation 408, the digital asset transfer management engine compares the first quantity of the digital asset to the second number of confirmatory transactions by the e-commerce platform to verify current inventory quantity of the digital asset. In particular, by comparing these numbers, a quantity of the available inventory of the digital asset may be determined.

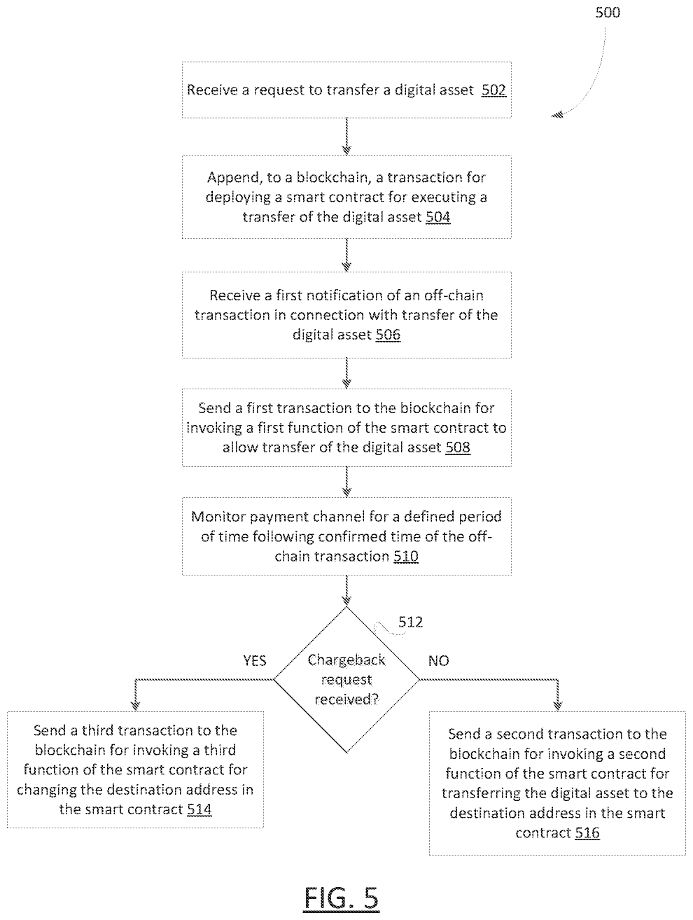

Reference is now made to FIG. 5, which shows, in flowchart form, another example method 500 for processing transfers of digital assets between parties. The method 500 may be performed by a computing system that implements asset transfer control, such as the digital asset transfer management engine 210 of FIG. 2. The digital asset transfer management engine may be a service that is provided within or external to an e-commerce platform to facilitate, among others, transfer of digital assets between merchants and customers associated with the e-commerce platform. In particular, the method 500 may be included as part of a process for transferring, in real-time, digital assets via a blockchain network. The operations of method 500 may be performed in addition to, or as alternatives of, one or more of the operations of method 300 of FIG. 3 and method 400 of FIG. 4.

Operations 502 to 508 correspond to operations 302 to 308 of method 300 and may be performed in a similar manner as those operations. In operation 502, the digital asset transfer management engine receives a request to transfer a digital asset of a merchant associated with the e-commerce platform using a blockchain network. A smart contract that controls the digital asset is created. In particular, the smart contract controls execution of transfer of the digital asset to a destination address. The smart contract is appended to the blockchain, in operation 504.

The digital asset transfer management engine receives a notification of an off-chain transaction in connection with transfer of the digital asset, in operation 506. In particular, a payment transaction for acquiring the digital asset from the merchant is processed, and a notification of the transaction is received by the digital asset transfer management engine (for example, from a payment processing system). The digital asset transfer management engine then sends a transaction to the blockchain for interacting with the smart contract to allow for transfer of the digital asset, in operation 508.

The digital asset transfer management engine may monitor a channel associated with the off-chain transaction for a defined period of time following the transaction (operation 510). For example, the digital asset transfer management engine may monitor a payment channel associated with a payment by a buyer of the digital asset for acquiring the digital asset from the merchant.

During the monitoring, the digital asset transfer management engine may detect a refund, or chargeback request, associated with the payment by the buyer. The digital asset transfer management engine determines whether a request to return the payment for acquisition of the digital asset back to the buyer is received, for example, by the payment processing system. A chargeback reverses a payment transaction from the buyer's bank account, credit card, and the like. If a chargeback (or refund) request in connection with the payment is received (operation 512), the digital asset transfer management engine processes a revocation of a transfer of the digital asset. In particular, the digital asset transfer management engine may interact with the smart contract to call a function for changing a destination address of the transfer of the digital asset (operation 514). The destination address may, for example, be changed to a wallet address associated with the merchant.

If, however, no chargeback request is received during the defined period of time, the digital asset transfer management engine proceeds to send a transaction to the blockchain for calling a function of the smart contract for initiating transfer of the digital asset to a current destination indicated in the smart contract (operation 516), i.e., a wallet address associated with the buyer. In this way, the smart contract allows for a rollback of a digital asset transfer that is contingent on whether a chargeback of the payment for acquisition of the digital asset is requested and/or processed.

### Example E-Commerce Platform

Although integration with a commerce platform is not required, in some embodiments, the methods disclosed herein may be performed on or in association with a commerce platform such as an e-commerce platform. Therefore, an example of a commerce platform will be described.

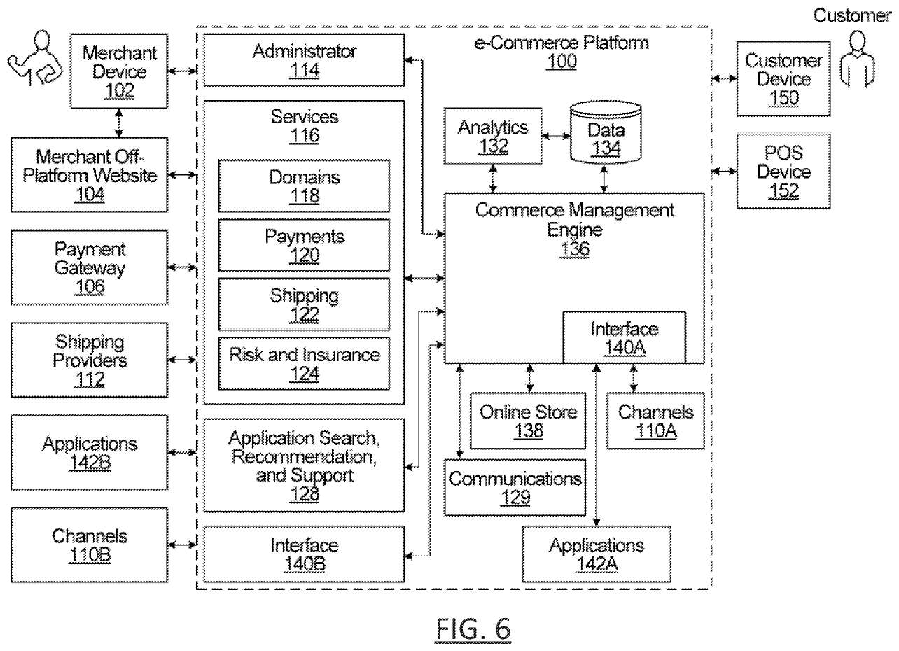

FIG. 6 illustrates an example e-commerce platform 100, according to one embodiment. The e-commerce platform 100 may be exemplary of the e-commerce platform 105 described with reference to FIG. 2. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a “merchant” and a “customer” may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to “merchants” and “customers”, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 6, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., “brick-and-mortar” retail stores), a merchant off-platform website 104 (e.g., a commerce Internet website or other Internet or web property or asset supported by or on behalf of the merchant separately from the e-commerce platform 100), an application 142B, and the like. However, even these “other” merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through “buy buttons” that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally, or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment facility 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

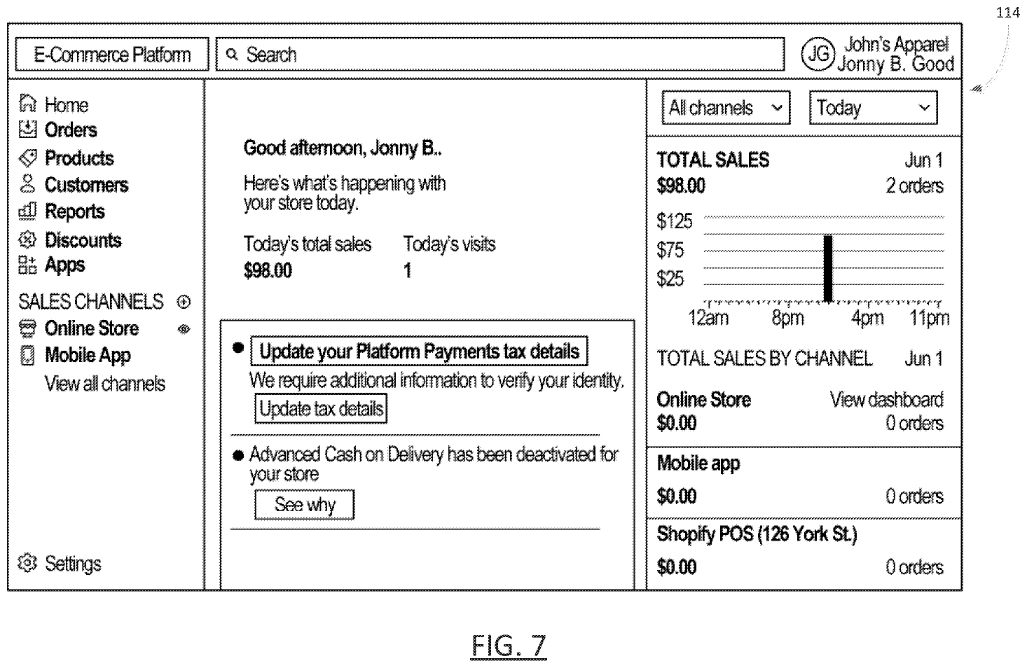

FIG. 7 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 7. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a “view all recent activity” dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as, for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 6, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) to transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and tracks quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

### Implementations

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In some embodiments, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4th Generation (4G) networks (e.g., Long-Term Evolution (LTE)) or 5th Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer-implemented method, comprising:
receiving a request to transfer a digital asset;
appending, to a blockchain of a blockchain network, a transaction for deploying a smart contract for executing a transfer of the digital asset;
receiving a first notification of an off-chain transaction in connection with transfer of the digital asset;
sending a first transaction to the blockchain for invoking a first function of the smart contract to allow transfer of the digital asset to a destination address; and
responsive to detecting a first condition associated with the off-chain transaction, sending a second transaction to the blockchain for invoking a second function of the smart contract for transferring the digital asset to the destination address.

2. The method of claim 1, wherein detecting the first condition comprises detecting expiry of a defined period associated with the off-chain transaction.

3. The method of claim 2, further comprising:
receiving a second notification of a request to process a chargeback prior to expiry of the defined period; and
responsive to the second notification, sending a third transaction to the blockchain for invoking a third function of the smart contract to change the destination address.

4. The method of claim 1, wherein the first and second transactions are sent using a digital wallet associated with an e-commerce platform that facilitates transfer of the digital asset from a seller offering the digital asset for sale on the e-commerce platform.

5. The method of claim 1, further comprising verifying inventory information for the digital asset, wherein the first transaction is sent in response to verifying the inventory information.

6. The method of claim 5, wherein verifying inventory information comprises:
determining a first quantity of the digital asset that is available for sale; and
comparing the first quantity to a second number of transactions sent by a digital wallet associated with an e-commerce platform for invoking a function of the smart contract to effect transfer of the digital asset.

7. The method of claim 6, wherein determining the first quantity of the digital asset comprises:
identifying one or more digital wallets controlled by a seller of the digital asset; and
determining a total quantity of the digital asset associated with the identified digital wallets.

8. The method of claim 1, wherein the off-chain transaction comprises a payment transaction in connection with the transfer of the digital asset, the payment transaction processed via a third-party payment gateway.

9. The method of claim 1, wherein the smart contract includes an indication of at least:
a seller wallet address for a digital wallet associated with a seller of the digital asset;
a buyer wallet address for a digital wallet associated with a buyer of the digital wallet; and
a platform wallet address for a digital wallet associated with an e-commerce platform.

10. The method of claim 1, wherein the digital asset comprises a non-fungible cryptographic token.

11. A computing system, comprising:
a processor;
a memory storing computer-executable instructions that, when executed by the processor, are to cause the processor to:
receive a request to transfer a digital asset;
append, to a blockchain of a blockchain network, a transaction for deploying a smart contract for executing a transfer of the digital asset;
receive a first notification of an off-chain transaction in connection with transfer of the digital asset;
send a first transaction to the blockchain for invoking a first function of the smart contract to allow transfer of the digital asset to a destination address; and
responsive to detecting a first condition associated with the off-chain transaction, send a second transaction to the blockchain for invoking a second function of the smart contract for transferring the digital asset to the destination address.

12. The computing system of claim 11, wherein detecting the first condition comprises detecting expiry of a defined period associated with the off-chain transaction.

13. The computing system of claim 12, wherein the instructions, when executed, further cause the processor to:
receive a second notification of a request to process a chargeback prior to expiry of the defined period; and
responsive to the second notification, send a third transaction to the blockchain for invoking a third function of the smart contract to change the destination address.

14. The computing system of claim 11, wherein the first and second transactions are sent using a digital wallet associated with an e-commerce platform that facilitates transfer of the digital asset from a seller offering the digital asset for sale on the e-commerce platform.

15. The computing system of claim 11, wherein the instructions, when executed, further configure the processor to verify inventory information for the digital asset, wherein the first transaction is sent in response to verifying the inventory information.

16. The computing system of claim 11, wherein verifying inventory information comprises:
determining a first quantity of the digital asset that is available for sale; and
comparing the first quantity to a second number of transactions sent by a digital wallet associated with an e-commerce platform for invoking a function of the smart contract to effect transfer of the digital asset.

17. The computing system of claim 16, wherein determining the first quantity of the digital asset comprises:
identifying one or more digital wallets controlled by a seller of the digital asset; and
determining a total quantity of the digital asset associated with the identified digital wallets.

18. The computing system of claim 11, wherein the off-chain transaction comprises a payment transaction in connection with the transfer of the digital asset, the payment transaction processed via a third-party payment gateway.

19. The computing system of claim 11, wherein the smart contract includes an indication of at least:
a seller wallet address for a digital wallet associated with a seller of the digital asset;
a buyer wallet address for a digital wallet associated with a buyer of the digital wallet; and
a platform wallet address for a digital wallet associated with an e-commerce platform.

20. The computing system of claim 11, wherein the digital asset comprises a non-fungible cryptographic token.

21. A non-transitory, computer-readable medium storing computer-executable instructions that, when executed by a processor, are to cause the processor to:
receive a request to transfer a digital asset;
append, to a blockchain of a blockchain network, a transaction for deploying a smart contract for executing a transfer of the digital asset;
receive a first notification of an off-chain transaction in connection with transfer of the digital asset;
send a first transaction to the blockchain for invoking a first function of the smart contract to allow transfer of the digital asset to a destination address; and
responsive to detecting a first condition associated with the off-chain transaction, send a second transaction to the blockchain for invoking a second function of the smart contract for transferring the digital asset to the destination address.
